(19) United States
(12) Patent Application Publication
(10) Pub. No.: US 2001/0008322 A1
(43) Pub. Date: Jul. 19, 2001

(54) THERMOPLASTIC AND THERMOSET COMPOSITE ARTICLES PROCESSES AND APPARATUS FOR THEIR PREPARATION

(76) Inventor: JAMES E. ROSENBAUM, GAINESVILLE, TX (US)

Correspondence Address: ROBERT W STROZIER, GILBRETH & STROZIER, PO BOX 61305, HOUSTON, TX, 772081305

(21) Appl. No.: 09/022,602

(22) Filed: Feb. 12, 1998

(51) Int. Cl. B29C 47/02; B32B 1/06

(52) U.S. Cl. 264/267; 264/241; 264/912; 264/920; 425/113; 428/36.9

(57) ABSTRACT

A composite article including a hollow form filled with a mixture of thermoplastic, a thermoset including ground whole tire waste and a processing aid. Also disclosed is a process for extruding a mixture of thermoplastic, thermoset including ground whole tire waste and a processing aid, in which the mixture is extruded through a die into a hollow form to form a filled article.

### BACKGROUND OF THE INVENTION

1. Field of the Invention

The present invention relates to thermoplastic and thermoset composite articles and methods for their manufacture. In another aspect, the present invention relates to articles having a plastic exterior filled with a thermoplastic and thermoset polymer composition wherein at least one of the polymers is recycled and to methods for their manufacture. In even another aspect, the present invention relates to a process and apparatus for filling plastic forms with an extruded mixtures of polyolefins and recycled rubber to form composite articles. In still another aspect, the present invention relates to a process and apparatus for filling a plastic form with an extruded mixture of polyethylene and tire particles to form composite articles. In even another aspect, the present invention relates to a process and apparatus for extruding mixtures of thermoplastic and thermoset polymers into a plastic form and to articles made therefrom, utilizing a processing aid. In yet another aspect, the present invention relates to the co-extrusion of a plastic exterior cover and an interior composition including thermoplastics and thermosets wherein at least one thermoset is derived from recycled cured rubber from tires and the like and optionally, a processing aid.

2. Description of the Related Art

Plastic materials are finding utility in more and more applications everyday. For example, plastics are used in all sorts of disposable applications such as diapers, product packaging, utensils, plates, cups, syringes, drink containers and shrink wrap. As another example, plastics are used as a major material of construction for electronic products such as telephones, computers, radios, stereos, kitchen appliances. As further example, plastics are utilized in automobiles in such applications as body molding, bumper guards, hoses, light covers, interior paneling, mud guards, floor mats and tires. In the construction industry, plastics are utilized in electrical wire, telephone wire, as paneling, horizontal surface tops, switches and moldings. Other examples, include the use of plastics in articles of clothing.

Unfortunately, as plastic materials proliferate into every facet of life, such materials become a larger portion of the waste stream. Disposable plastic items are used then disposed. Goods comprising plastic are trashed once the end of the useful life of the good is reached. Plastic waste is even generated during the process of making plastic articles in the form of off-spec material or “flash”. Off-spec material may be rejected because of appearance or physical property deficiency. “Flash” refers to excess polymer on a formed article that must be removed from the formed article. The environmental pressures of today stress the recycling of these waste plastic materials whenever possible.

Plastics fall into one of two categories, thermoplastics and thermosets.

Thermoplastics are polymers that will have a softening temperature and a melting temperature. Examples of thermoplastics include polyvinyl chloride, nylon, polyurethane and polyolefins, Heating a thermoplastic above its softening temperature will soften it, and heating it above its melting temperature will melt it. It is easy to see that thermoplastics can be formed into a shape, melted and reformed. Thus thermoplastics lend themselves to recycling.

Thermosets, on the other hand, do not readily lend themselves to recycling. A thermoset is a polymer that solidifies or “sets irreversibly. Examples of thermosets include, phenolics, polyesters, rubber and synthetic rubber. Since these polymers irreversibly set, heating them does not melt them into a reformable liquid. Thermosets are thus difficult to recycle.

As old vehicle tires are generally considered to constitute an environmental eyesore, many efforts have been made to recycle tires.

U.S. Pat. No. 3,210,301, issued Oct. 5, 1955, to White discloses a rubber compounding product that is made by recycling vulcanized reclaimed rubber from tires by first removing fibers and then mechanically working the rubber in the presence of 0.1-35 parts atactic polypropylene per hundred parts rubber.

Several patents disclose the use of rubber in making a molding composition. For example, U.S. Pat. No. 3,267,157, issued Aug. 5, 1955 to Siosberg et al., discloses that rubber granules may be mixed with a thermoplastic resin and molded into sheets. Also, U.S. Pat. No. 4,320,082, issued Mar. 15, 1982 to Houle, discloses a molding composition made from rubber, nylon and a vulcanizing agent, such as sulfur or magnesium oxide. U.S. Pat. No. 4,481,335, issued Nov. 6, 1984, discloses a rubber molding composition comprising tire rubber scrap, a sulfur curable polymeric binder and a curing agent for the binder. Finally, U.S. Pat. No. 4,795,503, issued Jan. 3, 1989 to Nagayasu, discloses an injection molding composition comprising 10-20 percent rubber particles and 70-90 percent polyethylene or polypropylene waste. However, these compositions are generally for batch type molding processes rather than a continuous extrusion type process.

U.S. Pat. No. 4,028,288, issued Jun. 7, 1977, and U.S. Pat. No. 4,003,408, issued Jan. 18, 1977, both to Turner, both disclose processes for reclaiming tire rubber utilizing particulated tires, but excluding the metallic content thereof. Turner '288 limits the amount of cord content to less than 10 percent. Thus neither Turner patent discloses a method for processing the whole tire.

Finally, U.S. Pat. No. 4,970,043, issued Nov. 13, 1990, discloses a method of recycling “high grade” rubber having reduced debris as compared to reground rubber obtained from many automobile tires. The high grade rubber is extruded with a thermoplastic to form a semi-stable moldable product which is then cooled to form a stable moldable product. Since this process requires “high grade” rubber, tires containing debris cannot be processed.

Applicant is the coinventor of grandparent application, now U.S. Pat. No. 5,312,573, which discloses an apparatus and process which reuse whole tire waste, including metal and fabric belts and tire beads. As disclosed in the '573 patent, the extrudate is dimensionally stable as it leaves the cooling chamber 58 of the extruder. As the extrudate travels along conveyor 96, it is subjected to cooling as it passes through ambient air.

Numerous attempts have been made to address the cooling of an extrudate as it leaves an extrusion die or cooling chamber.

Principles Of Polymer Systems, Ferdinand Rodriguez, McGraw-Hill, 1972, at 322-327, discloses that air-cooling may be utilized to cool an extrudate in order to gain dimensional stability.

U.S. Pat. No. 3,242,529, issued Mar. 29, 1966 to Parr et al., discloses a melt spinning apparatus with oppositely directed inert gas streams for continuously supplying an inert gas at the temperature of the spinnerette to the vicinity of the face of the spinnerette plate to prevent the occurrence of “drip”. The inert gas is provided under conditions that will not substantially alter the normal extrusion and cooling conditions.

U.S. Pat. No. 3,460,200, issued Aug. 12, 1969 to Zaitsev et al., discloses a cabinet for air-stream cooling of filament spun from a polymeric melt, in which a plurality of partitions form sections to provide guided travel of the air stream across the filaments to preclude whirls in the steam as well as its endwise motion along the filament bundle.

U.S. Pat. No. 3,502,763, issued Mar. 24, 1970 to Hartmann, discloses a process of producing non-woven fabric fleece in which fused polymer is extruded from spinnerette holes in filament form, and immediately thereafter seized on both sides by heated gas currents discharged from two slit-like openings in the direction of travel of the filaments.

U.S. Pat. No. 4,133,620, issued Jan. 9, 1979 to Lehner, discloses a polymer filament manufacturing device in which a cooling gas is passed across extruded filaments through a multiplicity of nozzles arranged on one side of the filaments.

U.S. Pat. No. 4,452,752, issued Jun. 5, 1984 to Harder et al., discloses a method and apparatus for extruding a thermoplastic shape along a shaped cooling surface.

U.S. Pat. No. 4,801,458, issued Mar. 7, 1989 to Oshima et al., discloses a process for extrusion-molding ceramic bodies, which includes continuously extruding a ceramic body through a die of an extruder and holding it on a porous support at a slightly floating shape by an air pressure which is jetted from pores of the support onto the underside of the ceramic body.

U.S. Pat. No. 5,108,277, issued Apr. 28, 1992 to Dixon, discloses an apparatus for cooling extruded material, which apparatus supports the extrudate on a cushion of air while controlling the temperature of the air.

U.S. Pat. No. 5,141,700, issued Aug. 25, 1992 to Sze, discloses a melt spinning process for polyamide industrial filaments, in which the freshly-extruded filaments enter an enclosed zone that is maintained at superatmospheric pressure by a controlled flow of air at low positive pressure and the filaments leave the zone through a constriction, either a venturi or a tube, assisted by the concurrent flow of such air at a high controlled velocity.

U.S. Pat. Nos. 5,312,573 and 5,523,328, issued May 17, 1994 and Jun. 4, 1996, respectively, to Rosenbaum et al.(incorporated herein by reference), disclose products and method for making the products that comprise thermoplastics and thermoset where the thermoset can comprise whole ground tire waste with or without metal tire constituents.

In spite of the above products and methods, there is a need for improved composite articles, methods and apparatus for their manufacture, where the articles include plastic exteriors filled with an extrudate containing thermoplastic and thermoset materials.

This and other needs in the art will become apparent to those of skill in the art upon review of this specification, including its drawings and claims.

### SUMMARY OF THE INVENTION

It is an object of the present invention to provide composite articles including an exterior filled with a thermoplastic/thermoset composition and to methods and apparatus for making the composite articles.

This and other objects of the present invention will become apparent to those of skill in the art upon review of this specification, including its drawings and claims.

According to one embodiment of the present invention, there is provided a composite article having an exterior filled with a composition comprising a mixture of at least one thermoplastic and at least one thermoset. The exterior can be made of any material, but is preferably a thermoplastic, a thermoset, a composite material such as fiber glass or the like, a metallic material or mixtures thereof.

According to one embodiment of the present invention, there is provided a process for making composite articles, which includes extruding a feed through an extrusion die into a pre-formed hollow form.

According to one embodiment of the present invention, there is provided a process for extruding an extrusion feed into a hollow form, which includes extruding a feed through an extrusion die to form an extrudate which is directed into the pre-made hollow form. The process can further include directing a cooling gas toward surfaces of the extrudate (top, bottom and sides) from a multiplicity of gas jets positioned around the periphery of the extrudate prior to directing the extrudate into the form. In a more specific embodiment, the extrusion feed can comprise one or more thermoplastics, and also may include one or more thermosets. In an even more specific embodiment, the extrusion feed may include ground tire waste and thermoplastic.

According to another embodiment, the present invention provides a process for producing useful filled hollow forms from ground whole tire waste and apparatus for accomplishing the process. The process includes continuously extruding a heated mixture of thermoplastic and ground whole tire waste into an open ended, hollow pre-made form. Alternatively, the extrudate can be directed into an open-ended casting chamber prior to introduction into the form. The casting chamber has a cross-section corresponding substantially to the cross-section of the cross-section of the form. The exterior surface of the casting chamber can be continuously cooled to remove a sufficient amount of thermal energy from the casting chamber such that a dimensionally stable extrudate emerges from its open end. As the cooled extrudate emerges from the chamber's open end, it is direct into a first end of the pre-made form. The filled form can be further cooled by directing cooling gas toward the form from a multiplicity of jets surrounding the form. The cooled form can then be cut to length.

According to even another embodiment of the present invention, the apparatus for accomplishing the above described process includes an extruder for extruding a mixture of thermoplastic and ground whole tire waste from an outlet of the extruder. An end nozzle is attached to the extruder outlet. The end nozzle has a frustroconical inner surface converging in the direction of extrusion. A transition nozzle is attached to the end nozzle. The transition nozzle has an inner surface that transforms from an inlet having circular cross-sections to an outlet having rectangular cross-sections. The extrudate can then be directed into the form to form a filled composite article. Optionally, the extrudate can be directed into a casting chamber having an inlet attached to the outlet of the transition nozzle which terminates at an open-ended outlet. The casting chamber has an uniform inner surface which is similar to and preferable substantially the same as the cross-section of the hollow form to be filled with the extrudate. The casting chamber is constructed and arranged to receive coolant about an exterior surface to remove thermal energy conducted from the inner surface. If a casting chamber its used, then positioned at the exit end of the casting chamber is the first end of the form to be filled with the extrudate. Preferably, a dimension of the extrudate is substantially equal to, slightly smaller than or slightly -Larger than the dimension of interior of the form. The plastic form can then be cooled by a multiplicity of gas jets, arranged to surround an form and to provide a cooling gas directed toward the form -from the each jet.

According to still another embodiment of the present invention, there is provided a process for making a composite or filled article by first forming a mixture comprising from about 5 to about 95 weight percent: thermoplastic, from about 0 to about 20 weight percent reinforcing material, from about 5 to about 95 weight percent thermoset particles, and form about 0 to about 10 weight percent of a processing aid, all based on the total weight of the mixture. The next step is heating the mixture to a temperature at least equal to or slightly above a highest melting point of the highest melting thermoplastic, but less than the degradation temperatures of both the thermoplastics and thermosets contained in the mixture. Then, extrude the mixture through a die having a cross-sectional shape substantially conforming to or slightly smaller than the shape of the interior of the form so that the form is substantially to completely filled by the mixture. Finally, the filled form can be cooled into the composite article, by directing cooling gas toward the article from a multiplicity of jets surrounding the article. The article can then be cut to length, if necessary.

According to yet another embodiment of the present invention, there is provided an apparatus for producing useful composite articles of a desired cross-sectional shape, from a mixture of thermoset and thermoplastic materials and optionally fillers and/or processing aids, the apparatus comprising an extruder for extruding an extrudate comprising the mixture through an extruder outlet and a forming nozzle attached to and adapted to receive the extrudate from the extruder outlet, wherein the nozzle comprises a nozzle outlet adapted to form the extrudate into a cross-sectional shape substantially equal to, slightly smaller or slightly larger than cross-sectional shape of a hollow form into which the extrudate is directed, and wherein the nozzle further comprises at some point prior to the nozzle outlet an expansion section having an inner cross-sectional shape that is greater than the cross-sectional shape of the form to be filled by the extrudate. Optionally, the apparatus can further comprise a cooling chamber attached to, adapted to receive extrudate from, and having substantially the same cross-sectional shape as the nozzle outlet, and further adapted to sufficiently cool extrudate into a stable matrix of the desired cross-sectional shape. Optionally, positioned at the exit end of the cooling chamber are a multiplicity of gas jets, arranged to surround an extrudate exiting the cooling chamber and to provide a cooling gas directed toward the extrudate from the each jet. As the extrudate exits the extruder, the cooling chamber or after jet cooling, the extrudate is feed into the form.

According to yet another embodiment of the present invention, there is provided a method for simultaneously extruding an exterior layer and a mixture comprising thermoplastic, ground tire waste, and optionally a filler and a processing aid. The exterior layer surrounds and encloses co-extruded mixture. The co-extruding method uses a standard duplex extruder assembly. Optionally, the article can include a second exterior layer using a triplex extruder assembly.

According to even still another embodiment of the present invention, there is provided a method of extrusion. The method includes extruding a mixture comprising thermoplastic, ground tire waste and optionally fillers and/or processing aids to form an extrudate which is then used to fill a hollow form. In a more specific embodiment, the ground tire waste comprises metal debris.

### BRIEF DESCRIPTION OF THE DRAWINGS

A more complete understanding of the invention and its advantages will be apparent from the Detailed Description of the Invention taken in conjunction with the accompanying drawings, in which like numerals refer to like and corresponding elements, and in which:

FIG. 1 is a schematic view of apparatus constructed to practice the process of the present invention.

FIG. 2 is a schematic, partially broken-away, enlarged, partial, side view of the apparatus of FIG. 1.

FIG. 3 is a sectional view taken along lines 3-3 of FIG. 2.

FIG. 4 is the Sectional view taken along lines 4-4 of FIG. 2.

FIG. 5 is a sectional view taken along lines 5-5 of FIG. 2.

FIG. 6 is a sectional view taken along lines 5-5 of FIG. 2.

FIG. 7 is a cross-sectional view of cooling apparatus 140, showing hollow tubing 148, gas jets 145, gas flow 146, gas supply line 142, gas supply control valve 143, and extrudate 94.

FIG. 8 is a cross-sectional view of cooling apparatus 140 of FIG. 7, taken at 8-8, with extrudate 94 not shown.

FIG. 9 is an isometric view of cooling apparatus 140 with extrudate 94 not shown.

FIG. 10 is schematic view of an embodiment of an extrusion apparatus for filling a hollow form 100 with extrudate 94.

FIG. 11 is schematic view of another embodiment of an extrusion apparatus for filling a hollow form 100 with extrudate 94.

FIG. 12 is one embodiment of an interlocking device for the filled hollow forms 200.

### DETAILED DESCRIPTION OF THE INVENTION

In accordance with the present invention, thermoplastic and thermoset materials are mixed together, heated to melt the thermoplastic, then extruded into a pre-made form to yield a filled, composite article.

Alternatively, the filled composite articles are made in a single manufacturing step by heating a mixture comprising thermoplastic and thermoset materials and an exterior composition, then co-extruding the mixture and the exterior composition forming a filled, composite article.

Thermoset materials useful in the present invention include any thermoset that when processed according to the present invention will yield a product having the desired properties. Mixtures of thermosets may be used. Generally, the thermoset utilized in the present invention includes at least one selected from the group consisting of rubber, phenolics, alkyds, amino resins, polyesters, epoxides and silicones. Preferably, the thermoset utilized in the present invention is rubber.

“Rubber” as used herein is intended to mean one or more of the following: natural rubber, polymers, interpolymers and copolymers of conjugated diolefins, i.e., polybutadiene, butadiene-styrene copolymers, butadiene-acrylonitrile copolymers, polymers and copolymers of methylpentadiene; polymeric forms of chlorine substitution products of conjugated diolefins, i.e., polychloroprene; polymers of non-conjugated systems, i.e., polyisobutylene and copolymers of isobutylene and isoprene; and condensation polymers of the polysulfide type.

The thermosets utilized in the present invention may be obtained from any source, including being produced in-situ in the process. However, it is generally commercially desirable that the thermosets utilized in the present invention be obtained as scrap or waste material.

When rubber is utilized as the thermoset material, it is generally desirable that scrap or waste rubber from tires be utilized In the process of the present invention, it is not critical that high grade rubber be utilized. Furthermore, in the process of the present invention, it is not critical that metal or fibers in the tire be removed. Rather, as one novel feature of the present invention, the process of the present invention is capable of processing whole tire into a useful composite article.

Generally, tires that may be processed in the present invention include truck, aircraft, heavy machinery, motorcycle, bicycle and automobile tires. Preferably, automobile tires are utilized in the process of the present invention. Tires typically comprise about 50-70 percent rubber, 20-30 percent steel and 5-10 percent textile fibers.

In the present invention, the percentage of thermoset in the mixture to be extruded will depend upon economic, process factors and the desired properties of the article to be produced. Generally, the mixture to be extruded and used to form filled composite articles will comprise in the range of about 5 to about 95 weight percent thermoset. Preferably, the filling mixture will comprise in the range of about 40 to about 94 weight percent thermoset. More preferably, the mixture will comprise in the range of about 50 to about 85 weight percent thermoset, and most preferably, in the range of about 50 to about 80 weight percent thermoset.

It must be remembered that the particle size of the thermoset materials fed to the extruder will not be drastically altered in the extrusion process. The particle size of the thermoset material processed in the present invention will generally be any size that will produce a desired filled article. Of course, the thermoset particle size should be smaller than the effective diameter of the filled article to be produced. The particle size of the thermoset material will also be dependent upon the processing capabilities of the equipment.

Generally, the particles of thermoset material utilized in the present invention will range in size from a fine powder to those with a diameter in the range of about 1/32nd inch to about 1 inch in diameter and in the range of about 1/32nd inch to about 10 inches long. Preferably, the thermoset material utilized in the present invention will be in the range of about 1/32nd inch to about ½inches in diameter and in the range of about 1/15th inch to about 3 inches long. The shape of the particle is not critical in the practice of the invention, but will be any shape that will allow for effective filling of a pre-made hollow form or that will provide a desired co-extruded product with acceptable end properties. Generally the shape will range from irregular, spherical to elongated and will be dependent upon the size reduction method utilized.

Large thermoset pieces may be reduced to smaller pieces utilizing techniques well known to those of skill in the art. Such techniques include milling, crushing, grinding, shredding, and cryogenic breaking processes in which the material is cooled in liquid nitrogen or the like and pulverized.

Thermoplastic materials useful in the present invention include any thermoplastic that when processed according to the present invention will yield a product having the desired properties. Mixtures of thermoplastics may be used. Generally, the thermoplastics utilized in the present invention includes at least one selected from the group consisting of polyolefins, polyvinyl chloride, nylons, fluorocarbons, polyurethane prepolymer, polystyrene, high impact strength polystyrene, cellulosic resins, acrylic resins, polyphenylene oxide, polyphenylene sulfide and mixtures and combination thereof. Preferably, the thermoplastic utilized in the present invention includes at least one selected from the group consisting of polyolefins, high impact strength polystyrenes and mixtures and combination thereof.

“Polyolefins” refers to polymers derived from simple olefins. The polyolefins may be homopolymers of C2-C20 alpha-olefins and may also be copolymerized with at least one selected from C2-C20 alpha-olefins and C3-C20 polyenes. Preferable polyolefins include ethylene and propylene which refer not only to the homopolymer, but also to polymers having 2 or more monomers in which at least one of the monomers is ethylene br propylene.

Most preferably, the thermoplastic utilized in the present invention includes at least one selected from the group consisting of polyethylene, polypropylene, high impact strength polystyrenes and mixtures and combination thereof.

The thermoplastic materials utilized in the present invention may be virgin materials, or may also be waste or scrap materials The particle size of the thermoplastic materials is not critical to the, practice of the present invention. The thermoplastic particles will be melted and reformed in the extrusion process. Therefore the particle size is dependent upon the processing capabilities of the equipment utilized.

In the present invention, the percentage of thermoplastic in the mixture to be extruded will depend upon economic, processing factors and the desired properties of the article to be produced. Generally, the mixture to be extruded will comprise in the range of about 5 to about 95 weight: percent thermoplastic. Preferably, the mixture to be extruded will comprise in the range of about 5 to about 50 weight percent thermoplastic. More preferably, the mixture will comprise in the range of about 15 to about 50 weight percent thermoplastic, and most preferably, in the range of about 20 to about 40 weight percent thermoplastic.

The pre-made forms utilized in the present invention may be any open ended hollow form made of any material which will not decompose or dissolve in the extrudate mixture of thermoplastic and thermoset. The pre-made forms can be plastic such as the same thermoplastics described above or the same thermoset as those mentioned above. Additionally, the form can be metal or composite such as fiber glass, graphite composites, or the like. The pre-made forms can be of any cross-sectional shape including, without limitation, circular, triangular, rectangular, square, oval, or any combination thereof. The only restriction or limitation to the nature of the cross-sectional shape is the shape should not adversely impact or impede extrusion of the thermoplastic/thermoset mixture into the form.

For co-extruded articles, the materials that become the exterior layer utilized in the present invention can be any extrudable material. Generally, the exterior layer material will be a virgin plastic material as described above. However, the exterior layer could also be an uncured thermoset such as unvulcanized rubber, epoxides, or any of the thermoset set forth previously. Similar to the thermoplastics utilized for the thermoplastic/thermoset mixture, the preferred exterior layer material are the same thermoplastics as described above.

Some desired end products may require the incorporation of reinforcing material for added strength. In addition to any reinforcing material that is part of the thermoplastic or thermoset materials utilized, other reinforcing material may optionally be added to provide added strength to the final produced product. For example, carbon, graphite and synthetic fibers may be added to the process. It is also possible to coextrude the mixture with continuous reinforcing fibers, matting or webbing oriented in the machine direction.

In the present invention, the percentage of reinforcing material in the mixture to be extruded will depend upon economic, processing factors and the desired properties of the article to be produced. When present in the mixture to be extruded, the reinforcing material will comprise in the range of about 1 to about 30 weight percent of the mixture. Preferably, the mixture to be extruded will comprise in the range of about 2 to about 20 weight percent reinforcing material.

In the process of the present invention, additives as generally known to those of skill in the extrusion art may be utilized. Such additives include processing aids, lubricants colorants, reinforcing fibers, stabilizers, antioxidants, fillers, conductive additives, heat stabilizers, blowing agents and plasticizers. Such additives, if utilized, will generally comprise in the range of about 0.1 to about 10 weight percent of the extrusion mixture.

In the practice of the present invention, suitable processing aid to be utilized are extender oils, asphalts, plasticizers, mixtures and combinations. Preferred processing aids are petroleum products such as asphalts or other asphaltic type materials, refinery bottoms or heavies, aromatic extender oils, naphthenic extender oils, paraffinic extender oils, gilsonite, plasticizers commonly used to improve the flow and extrusion properties of thermoplastics such as aliphatic long chained monools, oligomeric polymers, or the like, mixture or combinations thereof. The extender oils or asphalt will comprise in the range of about 1 to about 10 weight percent of the extrusion mixture, and most preferably, in the range of about 1 to about 5 weight percent of the extrusion mixture. The addition of the processing aid has been found to reduce shrinkage of the extrusion mixture upon cooling and to reduce cavitation in the extrusion mixture. Reduced shrinkage and cavitation of the extrusion mixture results in somewhat superior product.

The above described mixture must be heated to a temperature sufficient to melt the thermoplastic components, but not so great as to degrade any of the polymers in the mixture.

The present invention may be carried out in any apparatus that will sufficiently perform the necessary process steps and produce a product with the desired properties. The apparatus of the present invention will generally comprise a mixing section for receiving and mixing the thermoplastic and thermoset materials, a heating section for heating the mixture to the thermoplastic melting temperature, an extrusion section for extruding the mixture, a transition section connecting the extrusion section and the forming section, a forming section that comprises a die with the shape of the desired object, and a cooling section. These sections may be distinct sections, or they may be combined. For example, while not preferred, the thermoplastic and thermoset materials may be mixed in the extruder hopper.

In a preferred embodiment of the present invention, the cooling section will comprise a multiplicity of gas jets which are arranged to surround an extrudate, such that each gas jet will provide gas flow toward the extrudate. The multiplicity of jets may be used along with or instead of a cooling or casting chamber. Most preferably, the gas jets are arranged to surround the extrudate in a plane normal to plane in which the extrudate is traveling.

In a simple embodiment, the gas jets may comprise apertures, in tubing or piping. Such apertures will generally range from about 1/32″ to about ½″ in diameter, preferably in the range of about 1/16″ to about ¼″ in diameter, and even more preferably about ⅛″ diameter. Nozzles or other gas guides may also be provided to direct the cooling gas toward the extrudate. The gas jets will generally be spaced about 1/32″ to about 2″apart, preferably about ⅛″ to about 1″ apart.

The gas jets serve to both cool the extrudate, and to stabilize the extrudate from any sagging or rippling. The use of the gas jets is believed to increase the extrusion output. The extrusion output increase will depend upon the geometry of the extrudate, and other operating conditions. For example, applicant has found that in the making of extrudate having cross-sectional dimensions corresponding to conventional 2×8 lumber board, production can be increased at least 8%. As another example, applicant has found that in the making of ¾″ diameter “rope” to be ground into pellets, output increased from about 150 lbs/hour to over 300 lbs/hour. The gas velocity at the gas jets must be sufficient to provide the necessary cooling, and to prevent sagging and rippling of the extrudate. The cooling gas may be pumped or provided under pressure. Gas velocity will be determined by the gas jet diameter and gas pressure. For example, for 1/16″ to ⅛″ diameter apertures, generally about 20 psi to about 200 psi gas, preferably about 50 psi to about 100 psi gas, is sufficient to provide the necessary cooling and stabilizing effect.

The gas utilized in the gas jet cooler of the present invention may be any suitable gas that will not substantially negatively impact the extrudate. This, suitable gases will be a function of the composition of the extrudate, and the operating conditions. Generally, inert gases are suitable for use. Other suitable gases include air, nitrogen, and carbon dioxide.

The temperature of the gas utilized in the present invention is generally any temperature that will provide the desired cooling effect. It is expected that in numerous cases, ambient air will suffice.

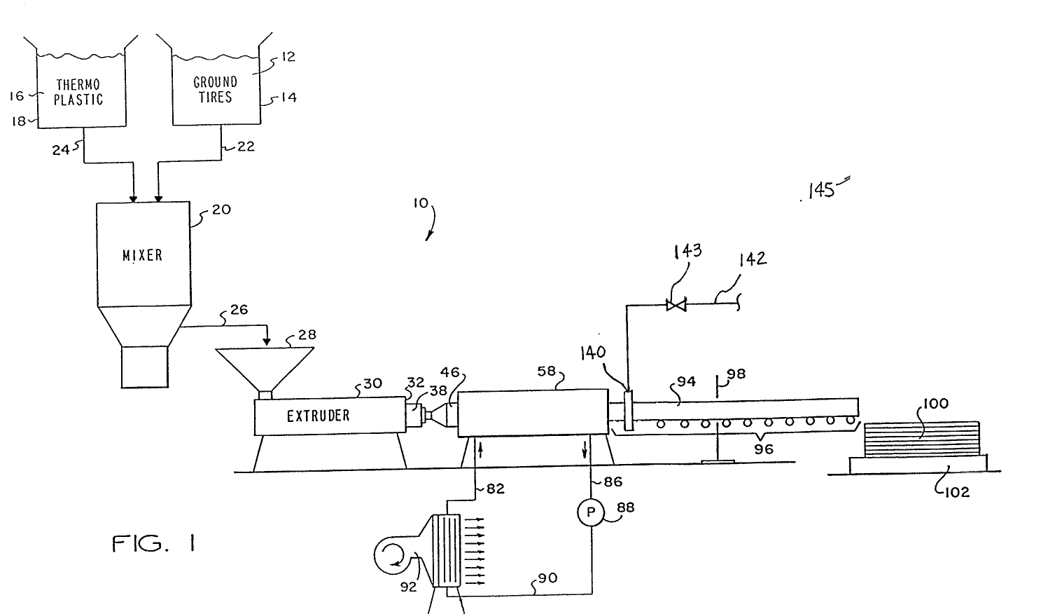

In the practice of the present invention, multiple extruders may be used to heat the various polymers utilized in the present invention. This may be economically beneficial when thermoplastics having greatly different melting temperatures are utilized. The thermoplastics may each be melted separately in different extruders and later combined together. It will also be necessary to heat the thermoset particles to the melting temperature of the thermoplastics so that when the polymers are mixed together, the thermoset particles will not cool the thermoplastics to below their melting temperature Referring now to FIGS. 1-7, there is illustrated one embodiment of an apparatus, generally 10, of present invention. The apparatus 10 is constructed and arranged to practice the process of the present invention, which is a process for producing useful filled hollow forms filled with a mixture of thermoset and thermoplastic polymer material in an extrusion filling process.

As shown, the mixing section comprises containers 14 and 18 and a mixer 20. The ground thermoset material 12 is initially delivered to the site in a container 14. The thermoplastic material 16 is delivered to the site in a container 18. The thermoset material 12 and the thermoplastic material 16 are conveyed in a predetermined proportion to the mixer 20, as indicated by arrows 22 and 24, where the starting materials are thoroughly premixed. The premix is then conveyed as shown by an arrow 26 to an inlet hopper 28 of an extruder 30.

In the embodiment shown, the heating and extrusion sections are combined in extruder 30. In Conventional fashion, the extruder 30 heats and conveys the premixed starting materials to an extruder outlet 32. The heating of the extrudate may be by any suitable means, such as for example, heated gases such as steam, heated liquids or oils, electrical heating elements and combinations thereof. In the embodiment shown, the extrudate is heated by way of electrical resistance coils 34 and conveyed by way of a screw 36.

In the transition section, a necessary pressure should be applied sufficient for the particular materials processed to achieve a desired consolidation, such that the final formed end product will have the desired physical properties. For example, for typically processed 50%/50% mixtures of polyethylene/tire rubber, the consolidation pressure must be in the range of about 200 psi to about 2000 psi.

This necessary consolidation pressure may be produced by a combination of several factors. The screw design, the shape of an end nozzle 38, the shape of a transition nozzle 46, and the shape of a transition outlet nozzle 54, all may effect the consolidation pressure. For example, consolidation pressure is increased by providing in the transition section, the end nozzle 38 converging in the direction of extrusion, the transition outlet nozzle 54, all converging in the direction of extrusion or combinations thereof.

In addition, consolidation pressure is increased if at some point in the transition section, the cross-sectional area of the extrudate is greater than the cross-sectional area of the die through which the extrudate will pass at the end of the transition section. If the extrusion outlet cross-sectional area is larger than the die cross-sectional area, then this condition is easily provided. If the extrusion outlet cross-sectional area is smaller than the die cross-sectional area, then at some point in the transition section, there must be an enlarged section to provide this condition.

In the embodiment shown, the consolidation pressure is obtained utilizing the proper screw design and an end nozzle 38 converging in the direction of extrusion. The transition section consists of the end nozzle 38 and the transition nozzle 46. As shown, the end nozzle 38 is tapered in such a manner as to increase the consolidation pressure in the transition nozzle 46.

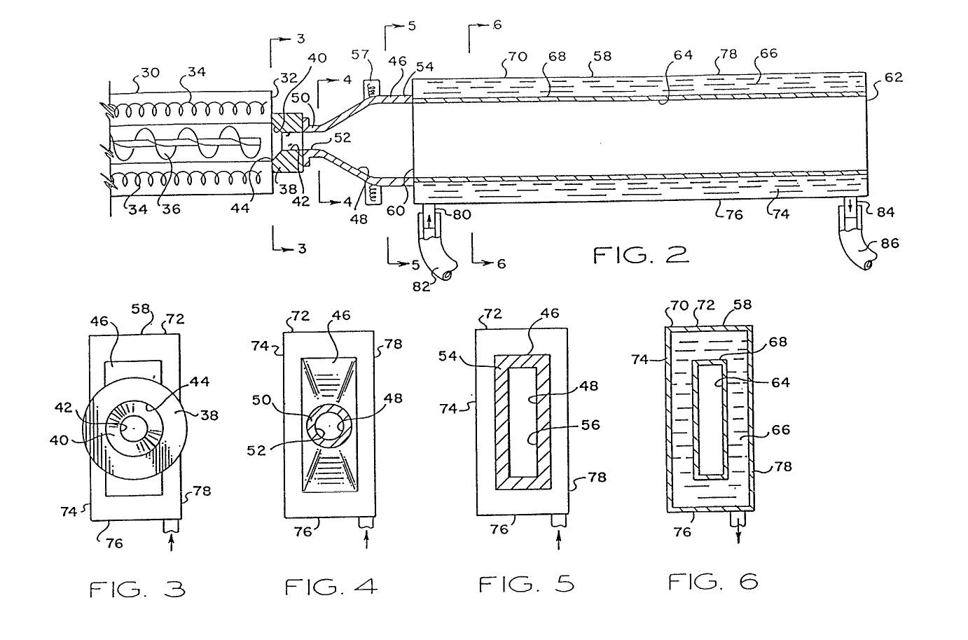

The end nozzle 38 is attached to the extruder outlet 32. As best shown in FIGS. 2 and 3, the end nozzle 38 has a frustroconical inner surface 40 converging in the direction of extrusion. The frustroconical inner surface 40 is joined to a cylindrical inner surface 42 having a cross-sectional diameter smaller in dimension than an inlet cross-sectional diameter 44 of the frustroconical inner surface 40.

The transition nozzle 46 is attached to the end nozzle 38. The transition nozzle 46 has an inner surface 48 that transforms from an inlet 50 having a cylindrical inner surface 52 with circular cross-sections, as best shown in FIG. 4. The inner surface 52 transforms to an outlet 64 having an inner surface 56. An inner surface 56 has rectangular cross-section, as best shown in FIG. 5. Heat may be supplied to the transition nozzle 46 by way of an electric resistance heating element 57.

In a preferred embodiment (not shown) to the transition section, the transition section will comprise a transition outlet nozzle 54 tapered in the direction of extrusion and at least one portion of the transition nozzle 46 will have a cross-sectional area greater than the cross-sectional area of the inner surface 46 at the outlet of the transition nozzle 46. The end nozzle 38 may optionally eliminated if sufficient consolidation pressure is obtained to produce end products having the desired physical properties.

After exiting the transition nozzle outlet 54, the extrudate 94 is directed into a hollow form 100 positioned and held in place at the outlet 54 by supporting member 102 as shown in FIG. 10. The hollow form 100 has a first open end 104 and a second open end 106. Of course, the second end 106 can also be closed; provided, however, that air vents (not shown) are provided at the second end so the air can escape from the form 100 as it is being filled by the extrudate. The extrudate 94 enters the first end 104 of the hollow form 100 until the form 100 is filled as indicated by the extrudate 94 exiting the second end 106 of the form 100 to produce a filled form 200. To aid filling, the interior surfaces of the hollow form 100 can be pre-coated with a lubricant or processing aid such as an extender oil or a processing oil can be added as the extrudate enters the form 100.

The transition nozzle outlet 54 can be optionally attached to a cooling chamber 58. Methods of cooling an extrudate that has passed through a die are well known, and any suitable method and apparatus may be utilized as the cooling chamber 58.

In the embodiment shown, the cooling chamber 58 has an inlet 60 attached to the outlet 54 of the transition nozzle 46 and an outlet 52 that is open-ended. The cooling chamber 58 has a uniform inner surface 64 with substantially the same cross-section as the surface 56 of the transition nozzle outlet 54. The cooling chamber 58 is constructed and arranged to receive a coolant 66 about an exterior surface 68 to remove thermal energy conducted from the inner surface 64. The exterior surface 68 is contained within a coolant jacket 70 formed by jacket walls 72, 74, 76, 78.

The coolant 66 is supplied to the coolant jacket 70 by way of an inlet 80 through a hose 82. The coolant 66 exits the jacket 70 through an outlet 84 and a hose 86. As best shown in FIG. 1, the coolant 66 is circulated by way of a pump 88, which conveys the coolant 66 through a hose 90 to a heat exchanger 92 before returning it to the jacket, 70 by way of the hose 82.

The amount of thermal energy to be removed by circulating the coolant 66 can be determined by routine experimentation, and is a factor of the volume of the jacket 70, the area of the surface 68, the length of the casting chamber 58, circulation rate established by the pump 88, and heat exchange capability of a heat exchanger 92. The cooling chamber 518 may be provided in sections, such that its total length is adjustable. Some sections may be liquid cooled while other sections are air cooled. The cooling system must be sufficient to reduce the skin temperature of the extrudate at the open end of cooling chamber 58 such that the extrudate is dimensionally stable during further cooling.

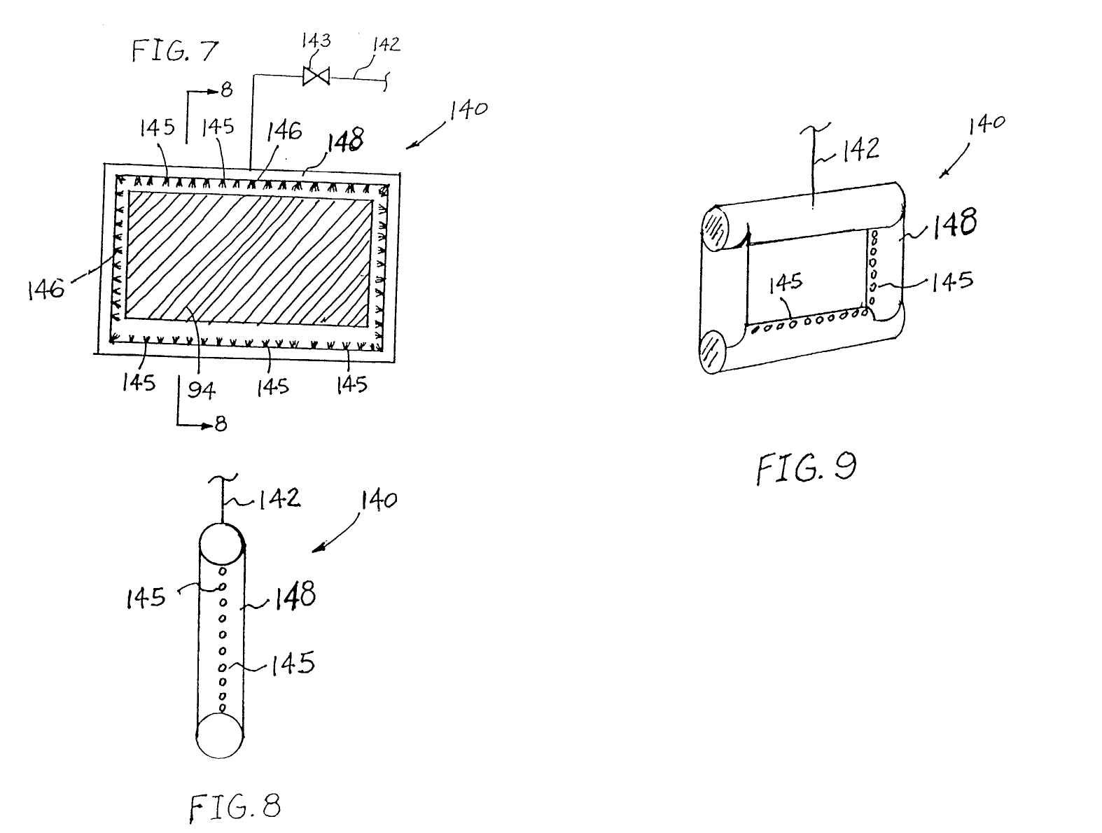

Positioned after the cooling chamber 58 is a gas jet cooler 140, which can been seen in. FIGS. 1, 7-9. A valve 143 controls the cooling gas flow to the gas jet cooler 140 through a gas line 142. The gas jet cooler 140 provides further cooling of a extrudate 94. As shown in FIG. 7, the extrudate 94 is supported and cooled by a gas 146 exiting jets 145, which surround the extrudate 94.

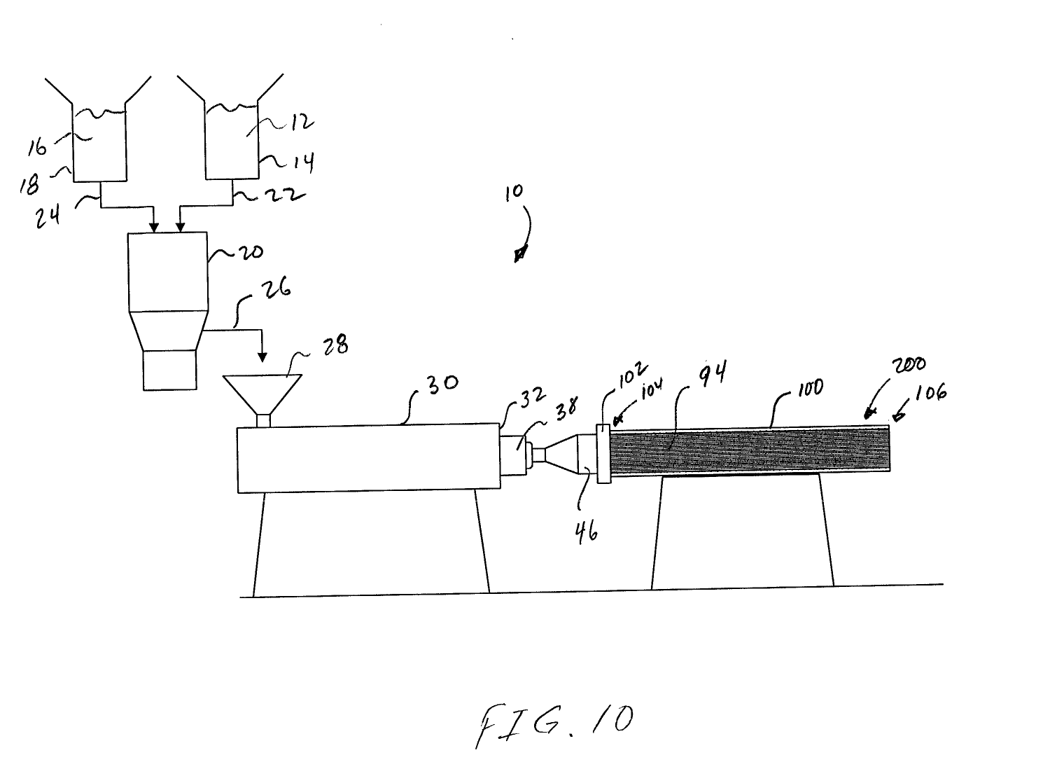

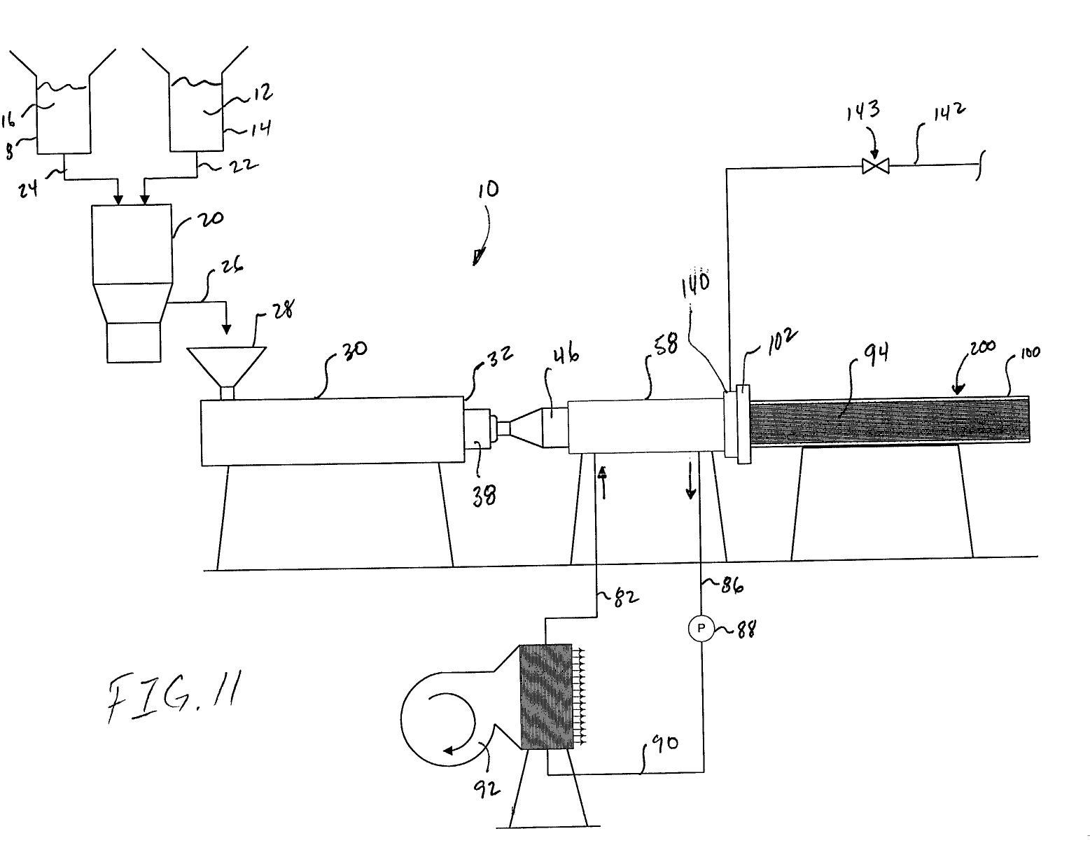

The gas jets 145 may comprise apertures or nozzles or any other such gas direction apparatus. In the embodiment shown in FIGS. 8 and 9, the gas jets 145 comprises apertures in the gas jet cooler 140.

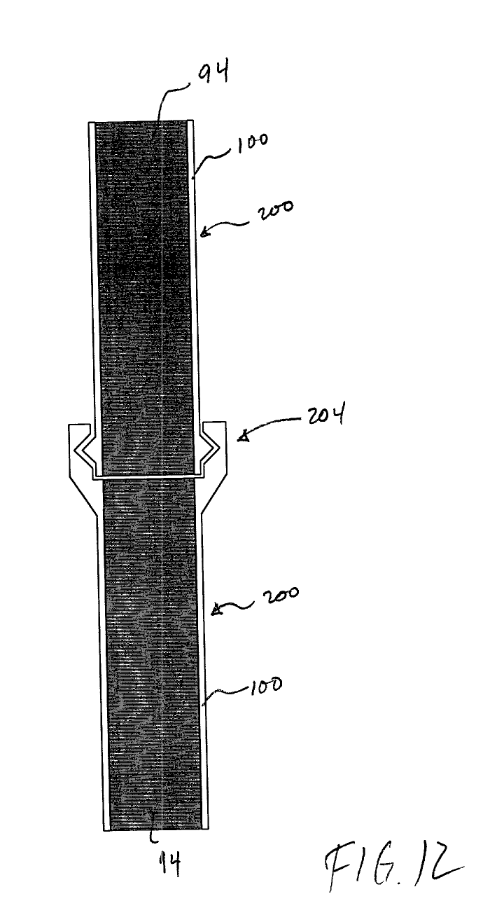

The extrudate 94 emerging from the gas jet cooler 140 and enters the hollow form 100 which is held in place at the end of the cooler 140 by the support member 102 as described previously to form a filled article 200 as shown in FIG. 11.

In the operation of this embodiment, a pre-mixed mixture of ground thermoset waste 12 and thermoplastic material 16 is continuously extruded by way of the extruder 30 into the interior of the cooling chamber 58. Typical temperatures for processing some polyethylene/tire rubber mixtures are in the range of about 350° F. to about 525° F. at the outlet 32. The cooling chamber 58 has a cross-section defined by the surface 64 that corresponds substantially to the cross-section of the hollow form 100. The exterior surface 68 of the casting chamber 58 is continuously cooled by way of the coolant 66 circulated through the exchanger 92. Sufficient thermal energy is removed from the casting chamber 58 such that the extrudate 94 is dimensionally stable as it emerges from the open end 62 of the casting chamber 58. The extrudate 94 can be further cooled by the gas jet cooler 140. After emerging from the cooler 140, the extrudate 94 is directed into the hollow form 100.

As can be seen, the hollow form 100 are members having a circular cross-section which have been cut to predetermined lengths prior to filling. However, the hollow form 100 can have any desired cross-section such as rectangular, square, triangular, oval, or any other shape. Moreover, the hollow form 100 can be such that the form has interlocks 204 as shown in FIG. 12 which shows one interlocking end arrangement. Of course, it should be recognized that any interlocking end device can be used included threaded connections, compression rings or sleeves or the like. The filled hollow forms 200 are ideal for use as building materials, and may be formed having cross-sections corresponding to conventional dimensional lumber, such as 2×4″s, 2×6's, 4×4's, etc. The filled hollow forms have a strength and fastener holding ability similar to or exceeding that of wood lumber, and are virtually indestructible. The articles can be sized from 1×1 (0.7511×75″) square cross-section all the way to large diameter, round utility poles. It is expected that the useful filled hollow forms will greatly out perform lumber in environmental conditions involving moisture, sunlight and extreme temperatures. Obviously, the use of one hundred percent waste material to produce a product which substitutes for lumber has substantial ecological benefit.

The material 12, the ground whole tire waste, is available from waste tire processors without any rubber, fabric or metal material removed. A key advantage of this invention is that the whole tire waste can be utilized, as opposed to many prior art attempts to utilize tire waste which require use of a “high grade” rubber, substantially free of foreign fabric and metal debris At present, ground whole tire waste is available from tire processors essentially free of charge.

The thermoplastic material 16 acts as a kind of “glue” or binder to bind the ground whole tire waste 12 together in the extrudate 94.

The interior surface 64 of the casting chamber 58 may be polished or coated with a fluoro polymer mold-release agent in order to affect the surface roughness of the articles. The extrudate may experience some shrinkage in dimension, so the cross-sectional area of the casting chamber 58 must be sized accordingly. The electric resistance heating element 57 may be required depending on the amount of transition in order to keep the extrudate in a plastic form until it begins to cool and harden in the casting chamber 58 or within the hollow form 100.

The ratio of tire waste to thermoplastic material establishes the characteristics of the filling medium. A fill mixture comprising six percent or less thermoplastic material by weight is very rubbery, has reduced strength and requires a relatively slow process rate due to a longer bonding time. A fill mixture produced with 60 percent or higher thermoplastic is very dense and resilient, but experiences undesirable changes in resilience with temperature. In extreme cold temperatures, the product becomes breakable.

It should be recognized that the properties of the material used to make the hollow form can be used to attenuate or augment the properties of the filled hollow form regardless of the nature of the fill mixture. However, the fill mixture of the present invention will generally have a tensile strength, as measured by ASTM D412, of at least 850 psi. Preferably, the product of the present invention will have a tensile strength of at least 1000 psi, and most preferably a tensile strength of at least 1500 psi.

The fill mixture of the present invention will generally have an elongation in the range between about 0 to about 300 percent. Preferably, the elongation will be in the range of about 5 to about 100 percent. Most preferably, in the range of about 5 to about 40 percent.

The fill mixture of the present invention generally will have a shore A hardness greater than about 70. Preferably, the fill mixture of the present invention will have a shore A hardness greater than about 80. More preferably, the fill mixture of the present invention will have a shore A hardness greater than about 90, and most preferably greater than about 100.

The fill mixture of the present invention will generally have a screw retention, as measured by ASTM E588, of at least 300 lbs. Preferably, the fill mixture of the present invention will have a screw retention of at least 450 lbs., and most preferably at least 500 lbs.

The specific gravity of the fill mixture of the present invention will generally depend upon the thermoset and thermoplastic materials utilized and the operating conditions. Generally, the specific gravity of the fill mixture of the present invention will be at least about 0,8. Preferably, the specific gravity will be in the range of about 0.9 to about 1.1.

Whereas the present invention has been described with respect to a specific embodiment thereof, it will be understood that various changes and modifications will be Suggested to one skilled in the art, and it is intended to encompass such changes and modifications as fall within the scope of the appended claims.

I claim:

1. A method of making a filled article, comprising the step of extruding an extrusion feed into a hollow form to produce the filled article.

2. The method of claim 1, wherein the feed comprises a thermoplastic.

3. The method of claim 1, wherein the feed comprises a thermoplastic and thermoset.

4. The method of claim 3, wherein the thermoset comprises ground tire waste.

5. The method of claim 4, wherein the ground tire waste includes metal debris.

6. The method of claim 4, wherein the thermoplastic comprises at least one selected from the group consisting of polyolefins, polyvinyl chloride, nylons, fluorocarbons, polyurethane prepolymer, polystyrene, high impact strength polystyrene, cellulosic resins, acrylic resins, polyphenylene oxide, polyphenylene sulfide and mixtures and combination thereof.

7. The method of claim 4, wherein the hollow form comprises plastic, metal, composites, mixtures and combination thereof.

8. The method of claim 1, wherein the feed comprises a thermoplastic, thermoset and a processing aid.

9. The method of claim 8, wherein the thermoset comprises ground tire waste.

10. The method of claim 9, wherein the ground tire waste includes metal debris.

11. The method of claim 9, wherein the thermoplastic comprises at least one selected from the group consisting of polyolefins, polyvinyl chloride, nylons, fluorocarbons, polyurethane prepolymer, polystyrene, high impact strength polystyrene, cellulosic resins, acrylic resins, polyphenylene oxide, polyphenylene sulfide and mixtures and combination thereof.

12. The method of claim 9, wherein the processing aid comprises at least one selected from the group consisting of extender oils, asphalts, plasticizers, and mixtures and combinations thereof.

13. The article of claim 9, wherein the hollow form comprises plastic, metal, composites, mixtures and combination thereof.

14. An apparatus for extruding an extrusion feed into a hollow form, comprising:
(a) an extruder, having an exit end from which the feed exits; and
(b) a member for holding the hollow form so that the feed enters a first end of the hollow form as it exits the extruder.

15. The apparatus of claim 14, further comprising:
(c) a multiplicity of gas jets adjacent the exit end, and positioned to direct cooling gas toward the extruded feed in a plane normal to the direction of extrusion of the extruded feed as it enters the hollow form.

16. A method of extrusion comprising the steps of:
(a) extruding a mixture comprising thermoplastic, ground tire waste and a processing aid; and
(b) directing the mixture into a first end of a hollow form to form a filled form.

17. The method of claim 16, further comprising:
(C) cooling the feed as it enters the hollow form.

18. The method of claim 16, wherein the ground tire waste includes metal debris and the processing aid comprises at least one selected from the group consisting of extender oils, asphalts, plasticizers, mixtures and combinations thereof.

19. An article comprising a hollow form filled with an extruded composition comprising thermoplastic, thermoset and a processing aid.

20. The article of claim 19, wherein the thermoset comprises ground tire waste.

21. The article of claim 20, wherein the ground tire waste includes metal debris.

22. The article of claim 20, wherein the thermoplastic comprises at least one selected from the group consisting of polyolefins, polyvinyl chloride, nylons, fluorocarbons, polyurethane prepolymer, polystyrene, high impact strength polystyrene, cellulosic resins, acrylic resins, polyphenylene oxide, polyphenylene sulfide and mixtures and combination thereof.

23. The article of claim 20, wherein the processing aid comprises at least one selected from the group consisting of extender oils, asphalts, plasticizers, and mixtures and combinations thereof.

24. The article of claim 20, wherein the hollow form comprises plastic, metal, composites, mixtures and combination thereof.
